(19) United States
(12) Patent Application Publication
(10) Pub. No.: US 2010/0298996 A1
(43) Pub. Date: Nov. 25, 2010

(54) METHOD FOR OPERATING A POWER STATION

(76) Inventors: Jörg Gadinger, Nürnberg (DE); Jan Heller, Nürnberg (DE); Bernhard Meerbeck, Frankfurt (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/682,807

(22) PCT Filed: Oct. 16, 2008
(86) PCT No.: PCT/EP2008/063960

§ 371 Date: Jun. 17, 2010

(30) Foreign Application Priority Data
Oct. 16, 2007 (DE) 10 2007 049 764.6

(51) Int. Cl. G05B 13/04; G06F 1/26

(52) U.S. Cl. 700/291; 700/292; 706/23

(57) ABSTRACT

A method for operating a power station and a process control technique for a power station is provided. The method includes determining at least one desired operating parameter for a future moment in time when the power station is running. An artificial neuronal network integrated into the process control technique of the power station determines a characteristic which is valid for the future moment and depends on a plurality of influencing variables, or a characteristic derived therefrom. The process control technique automatically uses the characteristic to carry out a regulating and/or controlling intervention in the operation of the power station in order to achieve the desired operating parameter. The control and protection system for a power station including the integrated artificial neuronal network is also provided.

### CROSS REFERENCE TO RELATED APPLICATIONS

This application is the US National Stage of International Application No. PCT/EP2008/063960, filed Oct. 16, 2008 and claims the benefit thereof. The International Application claims the benefits of German application No. 10 2007 049 764.6 DE filed Oct. 16, 2007. All of the applications are incorporated by reference herein in their entirety.

### FIELD OF INVENTION

The invention relates to a method for operating a power station and to a control and protection system for a power station.

### BACKGROUND OF INVENTION

In power stations, in particular steam power stations, in the event of a change in the electrical output of the power station (“powering up” or “powering down”) the procedure has previously been as follows: firstly the desired value of the electrical output is established. Then the thermal output required to achieve this desired output value is calculated using a fixed efficiency, i.e. constant in all load ranges, (for example 50%). The efficiency (boiler efficiency) constitutes the correlation between the desired electrical output and the thermal output (combustion of fuels) and is used to pre-control the fuel in the block regulating structures of the power station. Despite the fact that the efficiency is dependent on many parameters it is often only pre-calculated from design data in various providers' control and protection system solutions and adjusted as a fixed value or a value that is dependent on only one variable. If a parameter differs from the design data an incorrect quantity of fuel is pre-controlled as a result and deviations in the main controlled variables (generator output and superheated steam pressure) can occur during operation with load change.

### SUMMARY OF INVENTION

It is an object of the invention to improve operation of a power station.

This object is achieved by the subject matters of the invention disclosed in the independent claims. Advantageous embodiments of the invention are disclosed in the sub-claims.

The inventive method for operating a power station is characterized in that when the power station is running, by specifying at least one operating parameter desired for a future moment in time, an artificial neuronal network integrated in the control and protection system of the power station determines a characteristic valid for this future moment in time and dependent on a plurality of influencing variables, or a characteristic derived therefrom and by automatically using this characteristic the control and protection system carries out a regulating and/or controlling intervention in the operation of the power station to achieve the desired operating parameter.

The inventive control and protection system for a power station is characterized in that it comprises an integrated artificial neuronal network and a regulating and/or control component, the integrated artificial neuronal network being adapted to determine a characteristic dependent on a plurality of influencing variables by specifying at least one operating parameter desired for a future moment in time when the power station is running, and the regulating and/or control component being adapted for regulating and/or controlling intervention in the operation of the power station by automatically using this characteristic to achieve the desired operating parameter.

The control and protection system of a power station is taken to mean the control system in the power station's control room in which the data streams of the subordinate levels, such as signals from measurement, control technology and engineering, are combined to control or regulate and monitor the entire operating process.

By way of example it is assumed hereinafter that the characteristic to be determined by the artificial neuronal network is efficiency. The advantages of the present invention are likewise described on the basis of determination of efficiency. If the future efficiency for a specific desired electrical output is known, the future required thermal output, and therewith the future fuel requirement as well, can be determined and taken into account when regulating or controlling the fuel supply during powering up or down of the power station. Powering up or down of the power station is significantly more accurately possible in this case than when using a strictly predetermined efficiency. This leads to improved power station operation. Instead of the efficiency, for example the efficiency of a power station block or another main regulating structure of the power station, the idea underlying the present invention may also be used elsewhere, however. By using an artificial neuronal network integrated in the control and protection system of the power station it is therefore basically possible to determine a characteristic relevant to the operation of the power station and to then use this to regulate and/or control operation of the power station.

The invention proposes calculating in advance the efficiency of the power station for a specific future load point by specifying a preferred desired output value and by taking account of further parameters, such as the mass flows of the various fuels or the cooling water temperature. The calculation is made in this case using an artificial neuronal network that is integrated in the control and protection system of the power station. In other words, no separate, independent calculation of the efficiency executed on a third party system is made, the value of which would then first have to be incorporated in the power station's control system. Instead, the output quantity of the neuronal network is automatically used as the power station controller's input quantity. Creation and training of the neuronal network are power station-specific and take place over a relatively long period, for example several months. The efficiency of the power station is calculated for a large number of instants with constant power station operation on the basis of the real data records of the power station that are available.

By using the present invention it is possible to change the electrical output of the power station (“powering up” or “powering down”) as follows: after establishing a desired output value the future efficiency for the corresponding load point is determined using the artificial neuronal network integrated in the control and protection system of the power station. The fuel supply is pre-controlled in accordance with this efficiency information. In other words, the fuel supply is increased or decreased accordingly.

Compared with the methods known from the prior art, the present invention is therefore not only characterized in that

a variable efficiency is used at all, it is also essential that the efficiency (or another characteristic of power station operation) is determined by an artificial neuronal network which is directly integrated in the control and protection system of the power station and therefore intervenes directly (“online”) in the operation of the power station without human assistance being imperative for this purpose. In other words, operation of the power station in accordance with the determined characteristic is independently regulated and/or controlled by the control and protection system. If the preferred characteristic desired value of the power station is also specified without human assistance, for example on the basis of an automatic request within a power station network, the present invention allows completely autarkic power station control and/or regulation. In addition to making it possible to approach a preferred desired output value much more accurately, with the requirement for automatic re-regulation being minimized by use of a correction regulator, the present invention also means subjective, and therefore error-prone, human decisions relating to power station control can be largely eliminated. By integrating the artificial neuronal network in the control and protection system of the power station it is not necessary to provide a separate computer environment for operation of the neuronal network either. Additional sources of error can consequently be eliminated.

A basic idea of the invention is therefore to achieve particularly good control of a preferred desired output value by providing the future efficiency. It does not matter what type of power station is involved. The invention will be described hereinafter using the example of a steam power station. It also does not matter whether only a single type of fuel is available or whether—as in the exemplary embodiment described hereinafter—various fuels are used (such as natural gas, blast furnace gas and mixed coke gas).

The determined characteristic, here by way of example the efficiency, is preferably used less for regulating and more for controlling operation of the power station. The burden on regulation is eased as a very accurate pre-control value can be adjusted using the artificial neuronal network. In other words, (re)regulation is hardly still necessary.

The efficiency is determined by specifying a preferred desired value of the electrical output of the power station for a future load point. A limited number of operating parameters, and primarily the desired electrical output of the power station, is used to define this load point. Further operating parameters are the cooling water temperature and the energy fluxes and the heating values of the fuels used. In other words, the future efficiency does not result exclusively from taking into account the preferred desired output value. Instead, other influencing variables are also considered when determining the efficiency.

The present invention therefore results in an improved method for operating a power station by determining the efficiency in advance. As a result dramatically varying boiler performance can be better responded to in terms of control engineering. For this purpose an artificial neuronal network is used which displays the boiler performance of the power station and calculates the boiler efficiency “online”. The neuronal network is created and parameterized on the basis of the power station's data records which include all variables influencing the boiler efficiency. The network is fully integrated in the control and protection system and passes the boiler efficiency or a similar standardized variable on to the main regulating structures. This means that the neuronal network is established in the power station control and protection system, makes calculations “online” therein and is used directly to pre-control the fuel.

Instead of the actual boiler efficiency, the artificial neuronal network can also determine efficiency information that represents the efficiency, for example an efficiency-dependent variable.

### BRIEF DESCRIPTION OF THE DRAWINGS

The invention will be described in more detail hereinafter, in which;

FIG. 1 shows a flow chart for creating and inserting the neuronal network in the power station control and protection system,

FIG. 2 shows the basic structure of the invention with its essential components and

FIG. 3 shows a circuit diagram for pre-controlling the fuel.

### DETAILED DESCRIPTION OF INVENTION

The fluctuations in the electricity market have increased in recent years, not least of all owing to the increasing proportion of wind energy for the German and European power grids. In order to be able to operate economically an electricity supply company therefore endeavors to be able to react as quickly as possible with his power station fleet to short-term changes in the market. In the case of peak load power stations, such as gas turbine power stations are, it is relatively easy to vary the power station output in the short-term. Medium load power stations, like many coal-fired power stations for example, are also designed in order for it to be possible to constantly change the power station output when the power station is running, but much lower output gradients are possible with these power stations. The new conditions in the electricity market also mean that a medium load power station operator aims to run the maximum load gradients. This is only possible with very efficient and accurate control engineering, otherwise delayed regulating performance, over regulation of the desired value or oscillatory characteristics for example, can occur. Added to this is the further difficulty of strong variance in fuel quality in the case of this regulating function. This can be attributed to the changed acquisition strategies of the operators who frequently change their suppliers and increasingly use different types of fuel. The result is dramatically varying boiler performance for which many previous regulating concepts or methods are not sufficiently accurate. The problem of improved load regulation is therefore of increasing importance.

From the prior art it is known to use a wide variety of control loops in a power station. Some more complex control loops comprise pre-control and subsequent correction regulation. With a specified desired value the correcting variables are firstly approximately calculated from known process states or process states that are partially foamed in models. The inaccuracies caused by process faults are removed via the correction branch. The correcting variables are therefore available immediately for pre-control. It is not necessary for an error to occur first for a correcting variable to be generated. Pre-control is reactionless, i.e. the result of pre-control is not returned (instead only the controlled variable is). Pre-control ensures that the overall control loop is more stable as the correction regulator now only has to cover a small range of control. One requirement for this, however, is that pre-control operates with a certain level of accuracy. The aim of pre-control lies in accelerated command behavior.

It is precisely in processes with a large time constant for the controlled system (as applies for example to a power station boiler) that it is known from the prior art to supplement the control loop with pre-control. Otherwise greater differences in the main controlled variables, such as pressure and temperature of the live steam, or generator output, can occur as a result of the control process. If for example, an output gradient is run in a steam power station, the desired output value is firstly formed by a gradient-guided desired value. The speed of change in output, which is specified primarily by material properties of the boiler and turbine, is consequently not exceeded. If the currently present gradient-guided desired output value is divided by the block efficiency (gross) in the state of this desired output value, the associated stationary desired value (firing output) is obtained. This firing output is then used as the desired value for the cascade fuel control of the power station. Two fundamental problems occur with this principle of pre-control however:

Firstly, the block efficiency information is not available. If it were to be calculated use would have to be made of dynamic process data. This calculation would be very error-prone as many process variables, such as pressure and temperature of the water-steam circuit, only change with a very large time constant, while other variables (such as quantity of air and fuel) change very quickly. It would therefore also only be possible to calculate the current efficiency and not the efficiency of the pending desired output value. A further method would be advance calculation of the efficiency by way of an online simulation calculation. A very complex model of the power station plant would have to be created for this purpose, however, and the simulation would have to be so quick as to be able to supply a new value in every calculation cycle of regulation. The solutions known from the prior use neither of these methods as they are either very error-prone or would lead to satisfactory results only with immense calculating and planning effort.

Instead a constant efficiency is assumed for calculation of the firing desired output value. The accuracy of the result is very limited for this reason.

Secondly, only the stationary firing output of the desired value is obtained by calculating the firing output using pre-control. However it would not be possible to run the specified gradient using this firing output; the speed of change in output would be too low. In practice an additional sum would have to be added to the desired value of the firing output in order to obtain the desired speed of change and to control the steam storage and removal processes. A correction factor would be used for this purpose which adapts the calculated firing output desired value by way of addition (or subtraction). The correction factor is not a constant but a variable which is dependent on the change in the desired value and the specified speed of change. Ultimately the desired value of the firing output calculated in this way is corrected according to operation of the plant by the correction regulator, which in most cases is connected as a boiler pressure regulator.

With the present invention it is possible to calculate the efficiency without dynamic effects, in particular owing to the use of a neuronal network. The resulting firing output desired value is more accurate than would be the case with constant efficiency or with efficiency calculated using dynamic process data. A correction factor continues to be used but this is not disadvantageous because the more accurate calculation of the stationary firing output is, the less the error is increased in the case of this calculation due to the correction factor. This results in the correction regulator having to be corrected less as the main controlled variables are affected by smaller differences. The result is a more harmonic course and the output gradient can be run more accurately. This also means that in many cases it is possible to achieve the desired output value more quickly without exceeding the technical specifications in the process.

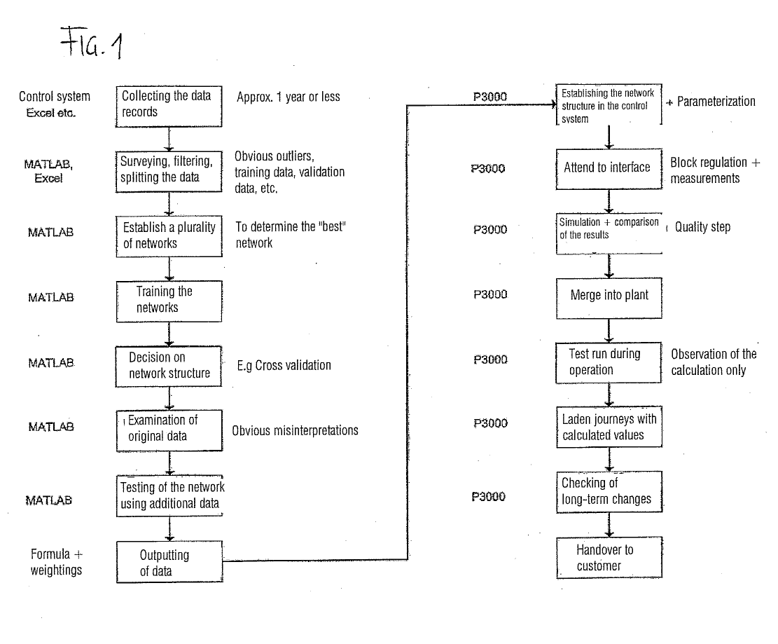

FIG. 1 shows a flow chart for creating and inserting the neuronal network in the power station control and protection system. In this case it is assumed by way of example that the neuronal network has first of all been created and trained (left-hand side of the graphic) and integration of the neuronal network in the control and protection system (“P3000”), i.e. the control system of the power station, follows thereafter (right-hand side of the graphic). The neuronal network was created and trained using the Microsoft Excel program and MATLAB.

For this purpose data records of a running power station were collected over a period of approximately 12 months in the example. These data records were then processed (surveying, filtering, splitting of the data) to remove obvious outliers and to determine subsequent training and validation data for parameterization of the neuronal network. A plurality of neuronal networks was firstly established and trained using the above-stated data as in the present example there was no experience with neuronal networks for applications of this kind. Using the method of cross-validation a decision was then made as to which network structure should be used. Once the structure of the neuronal network to be used was fixed the original data was examined to rule out obvious misinterpretations. The neuronal network was then extensively tested and this was done by also using additional data. At the end of this process a working neuronal network was available, with the aid of which the boiler efficiency of a steam power station could be determined.

The neuronal network was then integrated in the control and protection system of the power station. For this purpose the neuronal network was integrated in the structures of the control and protection system that are responsible for process optimization. After setting up the network structure in the control and protection system and corresponding parameterization, the interface of the neuronal network was attended to with respect to the component which is responsible for regulation and/or control of the individual power station blocks. Once the control and protection system had survived the quality check in the form of a simulation, actual start-up took place, beginning with a test run while the power station was running. Initially only the determined degrees of efficiency were considered during this test run, without this leading to a regulating and/or controlling intervention in the operation of the power station. Laden journeys with previously calculated values then took place in a next step. Since even checking over a relatively long period did not produce any deviations from the desired performance the power station control and protection system could be handed over to the customer who immediately then used it in the power station.

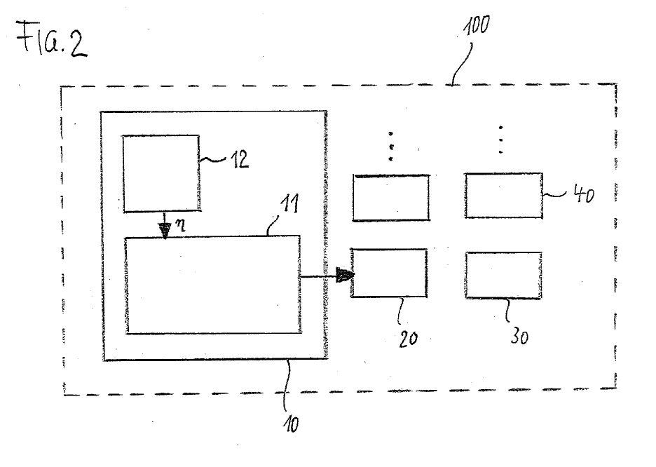

FIG. 2 shows the basic structure of the invention with its essential components. In addition to a control and protection system 10, the power station 100 includes a series of operating modules 20, 30, 40, inter alia a module 20 for fuel supply. In addition to a regulating and/or control component 11, which is used inter alia for regulating and/or controlling module 20 for fuel supply, the control and protection system 10 includes an artificial neuronal network 12. The output quantity of the neuronal network 12, the efficiency η of the power station, is used directly as an input quantity for the regulating and/or control component 11.

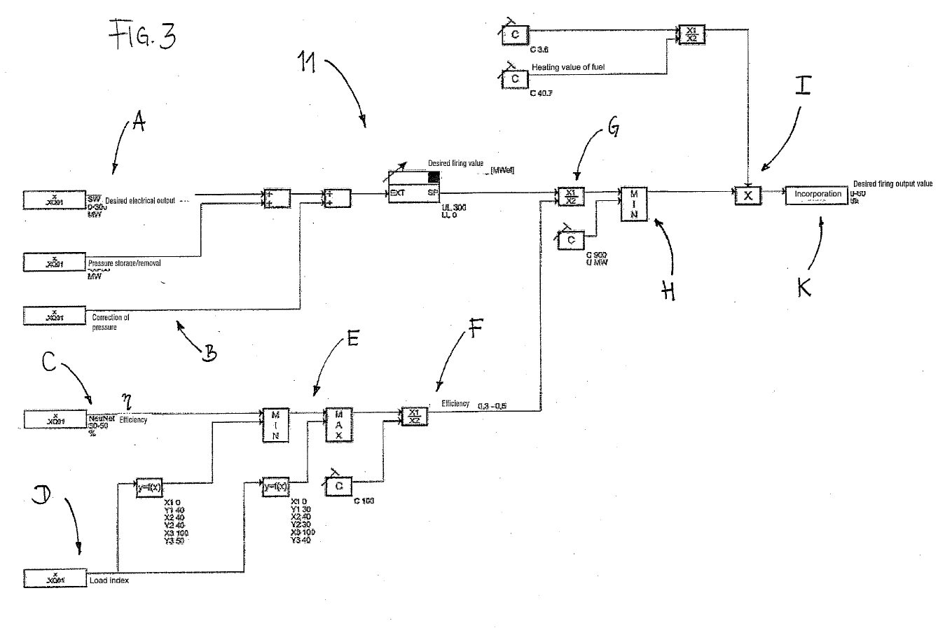

FIG. 3 shows a block diagram of the regulating and/or control component 11 with the aid of which pre-control of the fuel shall hereinafter be described.

The desired value of the electrical output (for example an electrical output between 0 and 300 MW) is provided as an input value for the control and protection system of the power station (see arrow A). In addition to specification of the desired electrical output, the pressure between boiler and turbine in a steam power station should always be kept to a specific desired value. An accumulator is used for this. As soon as the pressure has dropped the firing output has to be increased accordingly (see arrow B). A proportion of the required firing output is therefore used solely to keep the pressure between boiler and turbine at the required desired value rather than to increase the electrical output.

To achieve control of the power station in order to attain this electrical output (which also takes account of the desired pressure value), the desired electrical output must firstly be converted to the required thermal output. The efficiency of the power station is decisive in this regard and is calculated with the aid of an artificial neuronal network 12 integrated in the control and protection system 10. The efficiency η calculated in this way is provided as a further input value (see arrow C). The efficiency lies, by way of example, between 30 and 50%.

Depending on a load index, which can assume values between 0 and 100%, provided as an additional input quantity (see arrow D), the determined efficiency passes through two limiters (min, max) to exclude obvious defaults (see arrow E). For practical reasons the efficiency previously given in percent is then divided by 100, resulting in an efficiency between 0.3 and 0.5 (see arrow F). The desired electrical output value given in megawatts is then compared with the determined efficiency (see arrow G), resulting in a desired thermal output value which must not exceed a value of 900 MW. This is ensured in the example by a further limiter (min) (see arrow H). This desired thermal output value is then converted into a tonnage value using the heating value of the fuel used (firing output) (see arrow I). The firing output is between 0 and 60 tons per hour, for example. This firing output is required to attain the preferred desired electrical output value while simultaneously adhering to the desired pressure value, and is used to pre-control the corresponding power station block using operating module 20 (see arrow K).

1.-8. (canceled)

9. A method for operating a power station, comprising:
specifying an operating parameter desired for a future moment in time;
determining a characteristic by an artificial neuronal network valid for the future moment in time and dependent on a plurality of influencing variables, or the characteristic is derived from the plurality of influencing variables; and
carrying out a regulating and/or controlling intervention by a control and protection system in an operation of the power station to achieve the desired operating parameter by automatically using the characteristic,
wherein the method is used when the power station is running, and
wherein the artificial neuronal network is integrated in the control and protection system of the power station.

10. The method as claimed in claim 9, wherein the power station is a combined heating and power station.

11. The method as claimed in claim 9, wherein the power station is a thermal power station.

12. The method as claimed in claim 11, wherein the power station is a steam power station.

13. The method as claimed in claim 9, wherein the operating parameter is a desired electrical output of the power station.

14. The method as claimed in claim 9, wherein the characteristic is an efficiency.

15. The method as claimed in claim 14, wherein the characteristic is a boiler efficiency.

16. The method as claimed in claim 9, wherein the characteristic is an efficiency information representing the efficiency.

17. The method as claimed in claim 15, wherein the control and protection system carries out regulation and/or control of a fuel supply.

18. The method as claimed in claim 16, wherein the control and protection system carries out regulation and/or control of a fuel supply.

19. The method as claimed in claim 17, wherein the control and protection system carries out pre-control of a fuel component in a plurality of main regulating structures of the power station by automatically using the efficiency.

20. The method as claimed in claim 18, wherein the control and protection system carries out pre-control of a fuel component in a plurality of main regulating structures of the power station by automatically using the efficiency information.

21. A control and protection system for a power station, comprising:
an integrated artificial neuronal network adapted to determine a characteristic dependent on a plurality of influencing variables by specifying an operating parameter desired for a future moment in time when the power station is running; and
a regulating and/or control component adapted for regulating and/or controlling intervention in an operation of the power station by automatically using the characteristic to achieve the desired operating parameter.

22. The control and protection system as claimed in claim 19,
wherein the integrated artificial neuronal network is parameterized on a basis of a plurality of data records of a real power station, and
wherein the plurality of data records comprise a plurality of variables influencing the characteristic determined using the integrated artificial neuronal network.

23. The control and protection system as claimed in claim 20, wherein the plurality of influencing variables are selected from the group consisting of: electrical output of the power station, energy flux of the fuel, heating value of the fuel, and cooling water temperature.
